(19) United States
(12) Patent Application Publication
(10) Pub. No.: US 2006/0087406 A1
(43) Pub. Date: Apr. 27, 2006

(54) System and method for identifying an RFID reader

(76) Inventors: Bruce A. Willins, East Northport, NY (US); Richard M. Vollkommer, Smithtown, NY (US)

Correspondence Address: INGRASSIA FISHER & LORENZ, P.C., 7150 E. CAMELBACK, STE. 325, SCOTTSDALE, AZ, 85251, US

(21) Appl. No.: 10/973,520

(22) Filed: Oct. 26, 2004

(51) Int. Cl. H04Q 5/22

(52) U.S. Cl. 340/10.3; 340/10.1; 340/572.1

(57) ABSTRACT

An RFID reader according to the invention modulates the energizing preamble section of an interrogation sequence with a reader identifier that uniquely identifies that RFID reader within the RFID system. A suitable modulation scheme (for example, phase modulation) is utilized to ensure that the RF energy in the preamble remains sufficient to initialize passive RFID tags within the system. A diagnostic probe or other compatible device is configured to receive the ID-modulated interrogation sequence, demodulate the modulated section, and extract the reader identifier to resolve the identity of the transmitting reader.

### TECHNICAL FIELD

The present invention relates generally to radio frequency identification (“RFID”) systems. More particularly, the present invention relates to a system and method for identifying an RFID reader by modulating a portion of the interrogation sequence transmitted by the RFID reader.

### BACKGROUND

RFID systems are well known and the prior art is replete with different types of RFID systems, different applications for RFID systems, and different data communication protocols for RFID systems. Briefly, an RFID system includes two primary components: a reader (also known as an interrogator); and a tag (also known as a transponder). The tag is a miniature device that is capable of responding, via an air channel, to a radio frequency (“RF”) signal generated by the reader. The tag is configured to generate a reflected RF signal in response to the RF signal emitted from the reader. The reflected RF signal is modulated in a manner that conveys identification data back to the reader. Conventional RFID system operation does not require the identity of the readers to be made known during an interrogation cycle, i.e., the tags operate promiscuously with respect to the readers. Thus, many RFID protocols do not provision a method to uniquely identify the source of an interrogation transmission.

Some practical RFID system deployments include multiple RFID readers in relatively close proximity to each other. For example, a warehouse deployment may include readers positioned near multiple cargo bays, doorways, storage units, or the like. Furthermore, any number of portable handheld readers may be introduced into the RFID system environment. In these situations it is difficult to distinguish the identity of the reader performing the current interrogation cycle. Test equipment in the form of “sniffer” like devices or probes will be needed to analyze system performance and detect and isolate system faults. In this context, it is desirable to identify the source of the interrogation signal, i.e., to identify which reader is performing an interrogation cycle.

Accordingly, it is desirable to have a technique for identifying an RFID reader during its interrogation cycle. In addition, it is desirable to implement such an identifying technique in a manner that does not impact tag complexity, read cycle times, or standard RFID data communication protocols. Furthermore, other desirable features and characteristics of the present invention will become apparent from the subsequent detailed description and the appended claims, taken in conjunction with the accompanying drawings and the foregoing technical field and background.

### BRIEF SUMMARY

A system and method according to the invention enables identification of RFID readers by a suitably configured probe, diagnostic device, another RFID reader, other device, or a combination thereof. In one practical embodiment, at least a portion of the interrogation cycle, such as the preamble section or the tag energizing section, is modulated to convey an identifier for the reader. The identifier may be any number of bits, providing a globally unique identifier or an identifier that is unique within a local context. The modulation is chosen so as not to reduce the energy delivered to the tag during the time the modulation is present, not impact the tag's ability to interpret the preamble, and not affect the normal transmission and handling of the interrogation cycle. Thus, the identifier can be incorporated into an interrogation cycle that remains fully compliant with standard RFID data communication protocols, such as those set forth in EPC standards.

The above and other aspects of the invention may be carried out in one form by a method for identifying an RFID reader. The method involves obtaining an RFID reader identifier, modulating the RFID reader identifier into at least a portion of an interrogation sequence to produce an ID-modulated interrogation sequence for the RFID reader, and transmitting the ID-modulated interrogation sequence.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of an RFID environment including multiple RFID readers;

FIG. 2 is a generalized diagram of a conventional interrogation sequence for an RFID system;

FIG. 3 is a generalized diagram of an ID-modulated interrogation sequence for an RFID system according to the invention;

FIG. 4 is a schematic representation of an RFID reader configured in accordance with the invention;

FIG. 5 is a schematic representation of an RFID system diagnostic probe configured in accordance with the invention; and

FIG. 6 is a flow diagram of a process for transmitting and receiving an RFID reader identifier.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital processing elements, logic elements, look-up tables, or the like, which may carry out a variety of functions under the control of one or more microprocessors or other control devices. In addition, those skilled in the art will appreciate that the present invention may be practiced in conjunction with any number of RFID protocols and/or data transmission protocols and that the system described herein is merely one exemplary application for the invention.

For the sake of brevity, conventional techniques related to modulation, RFID data transmission, RFID system architectures, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

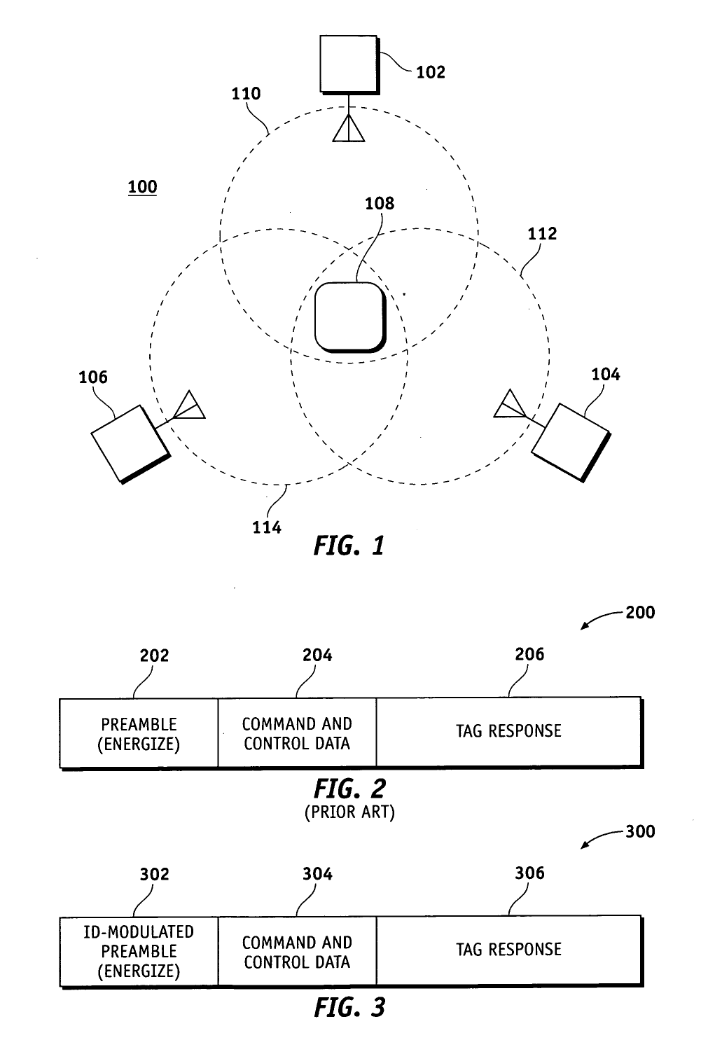

FIG. 1 is a schematic representation of an RFID environment 100 including multiple RFID readers 102, 104, 106. Although FIG. 1 depicts only three RFID readers, an actual RFID system deployment may include any number of RFID readers in close proximity to each other. The RF energy or signals in RFID environment 100 can be measured, detected, or otherwise diagnosed by a suitably configured diagnostic probe 108. Diagnostic probe 108 may be realized as a portable handheld device or it may be incorporated into another piece of equipment (including an RFID reader itself for operation in a diagnostic mode between interrogation cycles). FIG. 1 depicts an RF range or zone 110 corresponding to RFID reader 102, an RF range or zone 112 corresponding to RFID reader 104, and an RF range or zone 114 corresponding to RFID reader 106. In practical deployments, these RF zones may overlap with each other as depicted in FIG. 1.

In accordance with the invention, RFID readers 102, 104, and 106, and diagnostic probe 108 are configured such that diagnostic probe 108 can determine the source of received RF energy in environments having multiple, potentially overlapping, RFID readers. In the preferred embodiment, the content of interrogation sequences (for purposes of normal interrogation of RFID tags) initiated by RFID readers 102, 104, 106 need not be modified and the interrogation sequences thus remain compliant with standard RFID data communication protocols. Accordingly, conventional RFID tags are utilized in the context of RFID environment 100.

When implemented in software or firmware, various elements of the systems described herein (which may reside at the RFID readers or at the diagnostic probe) are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, an RF link, or the like.

FIG. 2 is a generalized diagram of a conventional interrogation sequence 200 for an RFID system. In a practical embodiment, interrogation sequence 200 may be compliant with a standard RFID data communication protocol, such as EPC Class 0, EPC Class 1, or EPC Class 1 Gen. 2. Generally, interrogation sequences for passive tag RFID systems begin with a preamble or tag energizing section 202, during which a continuous wave (“CW”) carrier is transmitted from the reader to initialize and energize tags located within the RF range of the reader. During the preamble, no information or data is transmitted by the RFID reader. Interrogation sequence 200 may also include a command and control data section 204, during which information is conveyed to the tags. Such information may vary from system to system, and the formatting of section 204 may vary depending upon the given RFID protocol. For example, such information may include oscillator calibration data, symbol calibration data, or global commands as used in the EPC Class 0 protocol, or the like. Interrogation sequence 200 also contains a tag response section 206 corresponding to the period during which the RFID tag responds to the reader. During this period, the reader transmits a CW signal and the tag (or tags) reflect the CW signal in an amplitude modulated manner that conveys the tag information back to the reader. Specific details of RFID interrogation sequences and their content are known to those skilled in the art and, therefore, will not be discussed herein.

FIG. 3 is a generalized diagram of an ID-modulated interrogation sequence 300 for an RFID system according to the invention. ID-modulated interrogation sequence 300 represents a data signal embodied in a carrier wave, where the data signal includes components that enable identification of the originating reader by a remote device such as a probe. In the illustrated example, ID-modulated interrogation sequence 300 includes an ID-modulated preamble or tag energizing section 302, a command and control data section 304, and a tag response section 306. ID-modulated preamble section 302 is modulated in response to an RFID reader identifier that identifies the transmitting reader. In the example embodiment, the RFID reader identifier is modulated into an otherwise conventional preamble section to produce ID-modulated preamble section 302. The RFID reader identifier is preferably modulated in a manner that does not impact the energizing function of the preamble. In other words, ID-modulated preamble section 302 maintains its ability to initialize and energize tags within the RF range of the transmitting reader. The modulation is chosen so as not to reduce the energy delivered to the tag during the time the modulation is present, not impact the tag's ability to interpret the preamble, and not affect the normal transmission and handling of the interrogation cycle. In one practical embodiment, the RFID reader identifier is phase modulated into a CW signal to produce ID-modulated preamble section 302. Alternatively (or additionally), the RFID reader identifier may be modulated into one or more other sections, segments, or portions of an RFID interrogation sequence that is otherwise formatted for compliance with a standard RFID data communication protocol. Furthermore, other suitable modulation techniques may be employed to modulate the RFID reader identifier into the preamble section while maintaining the energizing nature of the preamble. For example, some modulation schemes that generate constant envelope signals may be suitable for use with the invention.

In the example embodiment, ID-modulated interrogation sequence 300 remains compliant with a standard RFID data communication protocol (e.g., EPC Class 0, EPC Class 1, or the like). In this regard, command and control data section 304 and tag response section 306 need not be modified for purposes of the present invention. Consequently, the above description of command and control data section 204 and tag response section 206 also applies to command and control data section 304 and tag response section 306, respectively.

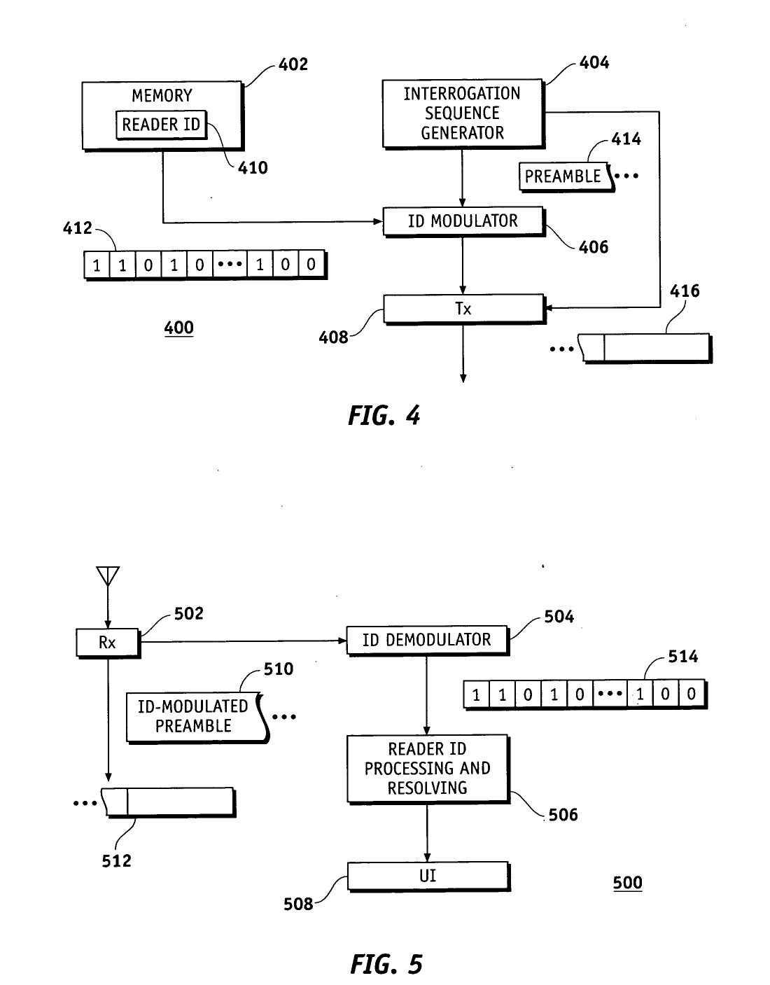

As described above, the ID-modulated interrogation sequence 300 is initiated, generated, and transmitted by the RFID reader. FIG. 4 is a schematic representation of an RFID reader 400 configured in accordance with the invention, namely, configured to generate and transmit an ID-modulated interrogation sequence that conveys a reader identifier. For the sake of brevity and clarity, conventional and well known elements of RFID reader 400 are not shown in FIG. 4.

RFID reader 400 may include a memory element (or elements) 402, an interrogation sequence generator 404, an ID modulator 406, and a transmitter 408. Although not shown in FIG. 4, a practical RFID reader 400 will also include a processor, such as any general purpose microprocessor, controller, or microcontroller that is suitably configured to control the operation of RFID reader 400. In practice, interrogation sequence generator 404, ID modulator 406, and/or transmitter 408 (or portions of such components) may be realized as hardware devices, logical elements, or functional elements.

Memory 402 may be realized as any processor-readable medium, including an electronic circuit, a semiconductor memory device, a ROM, a flash memory, an erasable ROM, a floppy diskette, a CD-ROM, an optical disk, a hard disk, an organic memory element, or the like. As described in more detail below, memory 402 is capable of storing at least one reader identifier 410 that identifies RFID reader 400. In the example embodiment, reader identifier 410 is a binary word, i.e., a sequence of digital bits, assigned to RFID reader 400. The number of bits in reader identifier 410 may vary from one system to another, and the number of bits should be large enough to enable the system to distinguish at least the number of distinct RFID readers deployed in the system. In once embodiment, the number of bits is large enough to enable the system to distinguish RFID readers in a global context. For example, reader identifier 410 may be the EPC identifier assigned to the RFID reader. The use of a digital reader identifier 410 is desirable in practical systems that utilize digital modulation and digital data communication techniques. Memory 402 is coupled to ID modulator 406 to facilitate communication of reader identifier 410 to ID modulator 406. An example digital reader identifier 412 is depicted in FIG. 4 as an output of memory 402.

Interrogation sequence generator 404 may be realized as processing logic that is configured to generate an interrogation sequence for an RFID transponder or tag. Interrogation sequence generator 404 may be coupled to ID modulator 406 and to transmitter 408. In the example embodiment, interrogation sequence generator 404 is suitably configured to initiate an interrogation sequence that is compliant with a standardized RFID data communication protocol. For example, interrogation sequence generator 404 may be configured to produce at least a portion of the sequence depicted in FIG. 1. As schematically depicted in FIG. 4, a preamble or energizing section 414 of the interrogation sequence is directed to ID modulator 406 and the remaining sections 416 of the interrogation sequence are directed to transmitter 408 because the remaining sections 416 need not be modulated. Alternatively, the entire interrogation sequence can be directed to ID modulator 406, which may be capable of selectively applying modulation to only a portion of the interrogation sequence.

ID modulator 406 is coupled to and communicates with both memory 402 and interrogation sequence generator 404. In this regard, memory 402, ID modulator 406, and any corresponding logical elements, individually or in combination, are example means for obtaining an RFID reader identifier for processing. ID modulator 406 is suitably configured to modulate RFID reader identifier 410/412 into at least a portion of the interrogation sequence. In the example embodiment, the preamble 414 serves as the portion of the interrogation sequence to be modulated by ID modulator 406. Ultimately, ID modulator 406 produces an ID-modulated interrogation sequence (or a portion thereof) for the given RFID reader. In practical implementations, ID modulator 406 may be configured to perform any number of modulation techniques, such as phase modulation (for example, phase shift keying (“PSK”) modulation) or other modulation techniques that do not impact the energizing function of the interrogation sequence. In systems that utilize amplitude shift keying (“ASK”) for reader-to-tag communications, the combination of ASK and PSK creates a constellation of phase and amplitude, or a simple M-ary system. It should be appreciated that ID modulator 406 is one example means for modulating the RFID reader identifier into the interrogation sequence.

Transmitter 408 is coupled to and communicates with ID modulator 406. In the illustrated embodiment, transmitter 408 is also coupled to and communicates with interrogation sequence generator 404. The output of ID modulator 406 (the ID-modulated portion of the interrogation sequence) may be transmitted first, followed by the unmodulated remaining sections 416 of the interrogation sequence. Alternatively, RFID reader 400 may be configured to combine the ID-modulated portion with remaining sections 416 to generate the ID-modulated interrogation sequence for transmission. In accordance with conventional RFID systems, transmitter 408 transmits the ID-modulated interrogation sequence over an air channel for possible reception by one or more RFID transponders, tags, other RFID readers, diagnostic probes, or the like. In this regard, transmitter 408 is preferably configured to transmit the ID-modulated interrogation sequence in compliance with a standard RFID data communication protocol, e.g., EPC Class 0, EPC Class 1, or the like. Since RFID readers generally emit significant power and the diagnostic probe can be in relatively close proximity to the readers, the signal-to-noise ratio is expected to be somewhat high, enabling sufficient information to be encoded to identify the readers. Notably, transmitter 408 is one example means for transmitting the ID-modulated interrogation sequence.

Although not a requirement of the system, it may be desirable for each RFID reader to be capable of generating an ID-modulated interrogation signal that conveys a reader identifier (or identifiers) that identify that particular reader. Thus, a suitably configured diagnostic probe could receive any number of ID-modulated interrogation sequences from any number of RFID readers and determine the sources of the received interrogation sequences using compatible demodulation techniques. In one practical embodiment, each interrogation sequence generated by an RFID reader is modulated with the specified reader identifier, thus ensuring compatibility with probes at all times.

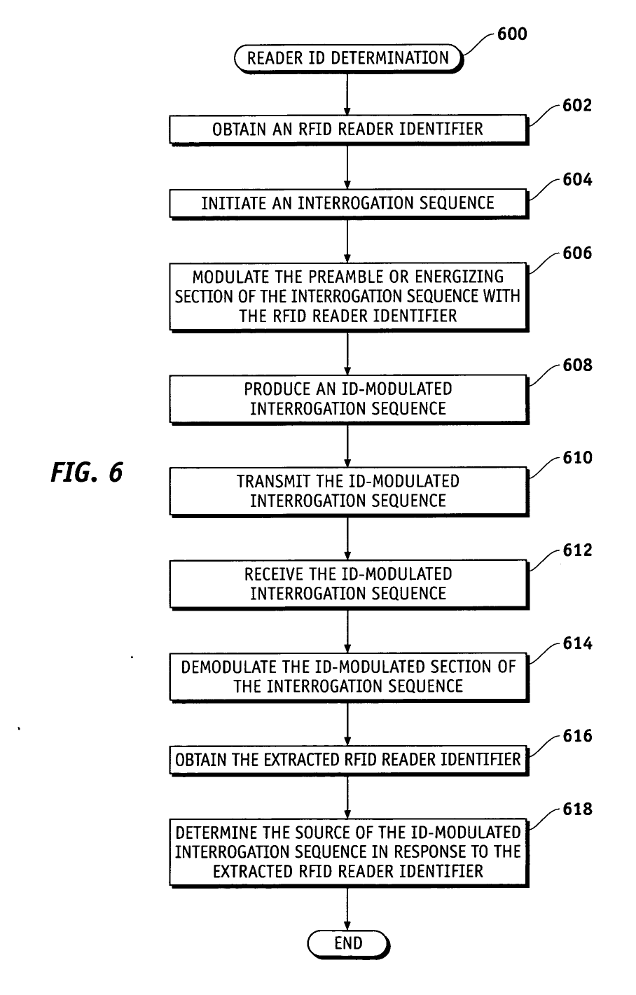

FIG. 5 is a schematic representation of an RFID system diagnostic probe 500 configured in accordance with the invention, namely, configured to receive the ID-modulated portion of an interrogation sequence that conveys a reader identifier and to resolve the identity of the transmitting RFID reader. Diagnostic probe 500 may be realized as a handheld “sniffer” device, realized as a stand-alone device, incorporated into a computing platform or system, incorporated into an RFID reader, or the like. If diagnostic probe 500 is incorporated into an RFID reader, the diagnostic functionality may be active between transmit interrogation cycles. For the sake of brevity and clarity, conventional and well known elements of diagnostic probe 500 are not shown in FIG. 5. For example, diagnostic probe 500 may include a suitable amount of memory, a processor, such as any general purpose microprocessor, controller, or microcontroller that is suitably configured to control the operation of diagnostic probe 500, and any number of logical elements configured to support the functionality of diagnostic probe 500.

Diagnostic probe 500 generally includes a receiver 502, an ID demodulator 504, processing logic 506 configured to perform various tasks associated with the processing and resolving of RFID reader identifiers as described herein, and a user interface 508. In practice, receiver 502, ID demodulator 504, processing logic 506, and/or user interface 508 (or portions of such components) may be realized as hardware devices, logical elements, or functional elements.

Receiver 502 is suitably configured to receive ID-modulated interrogation sequences transmitted within its RF reception range. In this regard, receiver 502 may be designed in accordance with conventional RF receiver circuit technology for the particular frequency band employed by the RFID system. In the example embodiment, receiver 502 is capable of receiving any number of ID-modulated interrogation sequences (limited only by practical operating conditions and restrictions) to determine the source of the RF energy associated with such sequences. Furthermore, receiver 502 is preferably configured to receive the ID-modulated interrogation sequences in compliance with the same RFID data communication or transmission protocol utilized by the RFID readers in the system. For example, receiver 502 may be compliant with EPC Class 0, EPC Class 1, or any appropriate RFID protocol. It should be appreciated that receiver 502 is one example means for receiving ID-modulated interrogation sequences (or the modulated section or sections thereof).

As mentioned above, an ID-modulated interrogation sequence includes an RFID reader identifier modulated into at least a portion thereof. In the example system, the preamble or tag energizing section of the interrogation sequence contains the modulated identifier. Thus, diagnostic probe 500 is schematically depicted such that the modulated preamble section 510 is directed to ID demodulator 504 while the remaining sections 512 of the ID-modulated interrogation sequence are directed elsewhere. In practice, the remaining sections 512 need not be processed or otherwise handled by diagnostic probe 500 and, therefore, may be discarded. Alternatively, the remaining sections 512 may be processed to record characteristics of the interrogation cycle to determine operational details of system performance and integrity. Alternatively, the entire ID-modulated interrogation sequence can be routed to ID demodulator 504, which may be designed to perform selective demodulation on the appropriate section or sections, or to simply disregard the remaining sections 512.

ID demodulator 504 is coupled to, and communicates with, receiver 502 to obtain the ID-modulated portion of the interrogation sequence. ID demodulator 504 is compliant with ID modulator 406 (see FIG. 4), i.e., ID demodulator 504 demodulates ID-modulated preamble 510 according to the modulation techniques employed by ID modulator 406. In practical implementations, ID demodulator 504 may be configured to perform any number of demodulation techniques, such as conventional phase demodulation (e.g., phase shift keying demodulation). As a result of the demodulation, diagnostic probe 500 obtains an RFID reader identifier 514 corresponding to the source of the received ID-modulated interrogation sequence. Notably, in this example, the extracted RFID reader identifier 514 corresponds to the stored RFID reader identifier 410/412 depicted in FIG. 4. ID demodulator 504 is one example means for demodulating ID-modulated interrogation sequences (or the modulated section or sections thereof).

ID demodulator 504 is also coupled to, and communicates with, processing logic 506 to facilitate further handling of the extracted RFID reader identifier 514. Processing logic 506 may be suitably configured to determine, in response to the extracted RFID reader identifier 514, the source of the received ID-modulated interrogation sequence. Processing logic 506 may resolve the identity of the transmitting RFID reader using, for example, a look-up table that associates RFID reader identifiers to their corresponding RFID reader devices. Although not a requirement of the invention, a straightforward system would assign only one RFID reader identifier per RFID reader, thus resulting in a unique and distinct RFID reader identifier for each RFID reader within the system. Of course, the number of unique RFID reader identifiers may be limited by the number of bits reserved for each identifier. Furthermore, RFID reader identifiers need not be unique in a global sense because a practical deployment will have a limited number of RFID readers and a limited RF range. In other words, the same RFID reader identifier can be used in different RF-isolated systems without adversely affecting the operation of processing logic 506 for any given local system. It should be appreciated that processing logic 506 is one example means for processing and resolving the extracted RFID reader identifiers.

Processing logic 506 is coupled to, and communicates with, user interface 508. User interface 508 conveys information to a user of diagnostic probe 500, where such information relates to the identification of one or more RFID readers. In a practical embodiment, user interface 508 may include a display, a printer, a speaker or other audio transducer, indicator lights or buttons, or the like. The information rendered on or by user interface 508 may include a listing of the RFID readers transmitting RF energy received by diagnostic probe 500, RF signal strength readings for the detected RFID readers, the RFID reader identifiers, the number of RFID readers detected, or the like. Of course, the specific configuration and operation of user interface 508 will vary depending upon the practical implementation of diagnostic probe 500.

FIG. 6 is a flow diagram of a reader ID determination process 600. The various tasks performed in connection with process 600 may be performed by software, hardware, firmware, or any combination thereof. For illustrative purposes, the following description of process 600 may refer to elements mentioned above in connection with FIGS. 1-5. In practical embodiments, portions of process 600 may be performed by different elements of the described system, e.g., RFID reader 400 or diagnostic probe 500. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein.

Reader ID determination process 600 assumes that the given RFID system includes at least one RFID reader configured as described above and at least one diagnostic probe configured as described above. Process 600 also assumes that the diagnostic probe is capable of resolving the identity of the transmitting RFID reader. In other words, the diagnostic probe has a priori knowledge of the RFID reader identifier corresponding to the transmitting RFID reader. In this regard, the RFID reader identifier may be pre-loaded into the diagnostic probe during an initialization procedure, entered into the diagnostic probe by a technician, transmitted to the diagnostic probe from the respective RFID reader, or the like.

Reader ID determination process 600 may begin by obtaining an RFID reader identifier for the given RFID reader (task 602). The RFID reader identifier may be obtained from a technician, from a software application, from a memory storage location in the RFID reader, or the like. In the example embodiment where the RFID reader identifier is already stored in the RFID reader, task 602 is performed by components of the RFID reader, e.g., memory 402 and/or ID modulator 406. Process 600 also initiates (task 604) an interrogation sequence intended for transmission to an RFID transponder, an RFID tag, and/or a diagnostic probe as described above. In the example embodiment, task 604 is performed by interrogation sequence generator 404. The entire interrogation sequence may be generated prior to further processing, or initial sections of the interrogation sequence may be processed and transmitted “on the fly” while subsequent sections of the interrogation sequence are being generated. In practical embodiments, the production of the interrogation sequence may be dynamic in nature, i.e., sections of the interrogation sequence may be generated and/or transmitted in response to communication with an RFID tag. As described above, the interrogation sequence is preferably initiated and generated to be in compliance with a standard RFID data communication protocol.

In the example embodiment, RFID interrogation process 600 modulates the preamble or energizing section of the interrogation sequence with the RFID reader identifier for the particular reader (task 606). In practice, task 606 is performed during the initialization or tag energizing period of the interrogation sequence, during which RF energy is received by RFID tags within the RF range of the RFID reader. In this example, task 606 is performed by ID modulator 406. As a result of the modulation, process 600 produces an ID-modulated interrogation sequence, or at least an ID-modulated portion of an interrogation sequence (task 608). In one preferred embodiment, phase modulation techniques are employed to generate the ID-modulated interrogation sequence.

RFID interrogation process 600 transmits the ID-modulated interrogation sequence (task 610), preferably in compliance with a standardized RFID data communication protocol. In a practical deployment, transmitter 408 may perform task 610, and the ID-modulated interrogation sequence may be transmitted in a “broadcast” manner without any specified destination device or target.

Assuming that a diagnostic probe or other compatible device is within the RF range of the reader, the probe receives the ID-modulated interrogation sequence (task 612). Receiver 502 may be configured to receive the ID-modulated interrogation sequence in a manner that is compliant with the standard RFID protocol used to transmit the sequence. Thereafter, RFID interrogation process 600 demodulates the appropriate section of the ID-modulated interrogation sequence (task 614) to extract the RFID reader identifier from the received sequence. As mentioned above, phase demodulation techniques may be employed during task 614. In this example, task 614 is performed by ID demodulator 504. As a result of the demodulation, process 600 obtains the extracted RFID reader identifier that corresponds to the transmitting RFID reader (task 616).

Ultimately, RFID interrogation process 600 analyzes or otherwise processes the extracted RFID reader identifier to resolve the identity of the transmitting RFID reader. In this regard, process 600 may determine the source of the ID-modulated interrogation sequence in response to the extracted RFID reader identifier (task 618). In the example embodiment, task 618 is performed by processing logic 506. In addition, process 600 may generate a suitable user interface, report, display, or other notification that contains information related to the identity of the transmitting RFID reader. Such information may be useful during diagnostic testing of an RFID system to determine RF reader coverage areas, RF power levels, and interference levels within the RF environment.

Following task 618, RFID interrogation process 600 ends. It should be appreciated that process 600 may be repeated for each interrogation cycle generated by an RFID reader, and that multiple and concurrent iterations of process 600 may be performed to support any number of RFID readers and any number of diagnostic probes. For example, one diagnostic probe can be configured to receive multiple ID-modulated interrogation sequences from a plurality of RFID readers, each having a different reader identifier.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for identifying an RFID reader, said method comprising:
obtaining an RFID reader identifier;
modulating said RFID reader identifier into at least a portion of an interrogation sequence to produce an ID-modulated interrogation sequence for said RFID reader; and
transmitting said ID-modulated interrogation sequence.

2. A method according to claim 1, wherein:
said ID-modulated interrogation sequence is in compliance with a standard RFID data communication protocol; and
said transmitting step transmits said ID-modulated interrogation sequence in compliance with said standard RFID data communication protocol.

3. A method according to claim 1, wherein modulating said RFID reader identifier comprises modulation that does not impact an energizing function of said interrogation sequence.

4. A method according to claim 1, wherein modulating said RFID reader identifier comprises phase modulation.

5. A method according to claim 1, wherein said RFID reader identifier is a binary word.

6. A method according to claim 1, wherein said modulating step modulates said RFID reader identifier into a preamble section of said interrogation sequence.

7. A method according to claim 1, wherein said modulating step occurs during a tag energizing period of said interrogation sequence.

8. A method for identifying an RFID reader, said method comprising:
receiving an ID-modulated interrogation sequence having an RFID reader identifier modulated into at least a portion thereof;
demodulating said ID-modulated interrogation sequence to obtain an extracted RFID reader identifier; and
processing said extracted RFID reader identifier to resolve the identity of an RFID reader associated with said extracted RFID reader identifier.

9. A method according to claim 8, wherein said ID-modulated interrogation sequence comprises said RFID reader identifier modulated into at least a portion of an interrogation sequence, said interrogation sequence being in compliance with a standard RFID data communication protocol.

10. A method according to claim 9, wherein said receiving step receives said ID-modulated interrogation sequence in compliance with said standard RFID data communication protocol.

11. A method according to claim 9, wherein said ID-modulated interrogation sequence comprises said RFID reader identifier modulated into a preamble section of said interrogation sequence.

12. A method according to claim 8, wherein said receiving step occurs during a tag energizing period of said ID-modulated interrogation sequence.

13. A method according to claim 8, wherein demodulating said ID-modulated interrogation sequence comprises phase demodulation.

14. A data signal for communicating information in an RFID system, said data signal being embodied in a carrier wave, said data signal comprising:
an interrogation sequence having content in compliance with a standard RFID data communication protocol; and
an RFID reader identifier modulated into at least a portion of said interrogation sequence, forming an ID-modulated interrogation sequence.

15. A data signal according to claim 14, wherein said ID-modulated interrogation sequence is in compliance with said standard RFID data communication protocol.

16. A data signal according to claim 14, wherein said RFID reader identifier is phase modulated into said at least a portion of said interrogation sequence.

17. A data signal according to claim 14, wherein said RFID reader identifier is modulated into a preamble section of said interrogation sequence.

18. A data signal according to claim 14, wherein said RFID reader identifier is modulated into a tag energizing section of said interrogation sequence.

19. An RFID reader comprising:
means for obtaining an RFID reader identifier;
means for modulating said RFID reader identifier into at least a portion of an interrogation sequence to produce an ID-modulated interrogation sequence for said RFID reader; and
means for transmitting said ID-modulated interrogation sequence.

20. An RFID reader according to claim 19, wherein:
said interrogation sequence is in compliance with a standard RFID data communication protocol; and
said means for transmitting transmits said ID-modulated interrogation sequence in compliance with said standard RFID data communication protocol.

21. An RFID reader according to claim 19, wherein said means for modulating comprises a phase modulator.

22. An RFID reader according to claim 19, wherein said means for modulating modulates said RFID reader identifier into a preamble section of said interrogation sequence.

23. An RFID reader according to claim 19, wherein said means for modulating modulates said RFID reader identifier into a tag energizing section of said interrogation sequence.

24. A diagnostic probe for an RFID system, said diagnostic probe comprising:
means for receiving an ID-modulated interrogation sequence having an RFID reader identifier modulated into at least a portion thereof;
means for demodulating said ID-modulated interrogation sequence to obtain an extracted RFID reader identifier; and
means for processing said extracted RFID reader identifier to resolve the identity of an RFID reader associated with said extracted RFID reader identifier.

25. A diagnostic probe according to claim 24, wherein said means for receiving receives said ID-modulated interrogation sequence in compliance with a standard RFID data communication protocol.

26. A diagnostic probe according to claim 24, wherein said means for demodulating comprises a phase demodulator.

27. An RFID reader comprising:
a memory for storing an RFID reader identifier that identifies said RFID reader;
processing logic configured to initiate an interrogation sequence for an RFID transponder; and
a modulator in communication with said memory and in communication with said processing logic, said modulator being configured to modulate said RFID reader identifier into at least a portion of said interrogation sequence to produce an ID-modulated interrogation sequence for said RFID reader.

28. An RFID reader according to claim 27, further comprising a transmitter in communication with said modulator, said transmitter being configured to transmit said ID-modulated interrogation sequence.

29. An RFID reader according to claim 28, wherein:
said processing logic generates said interrogation sequence in compliance with a standard RFID data communication protocol; and
said transmitter transmits said ID-modulated interrogation sequence in compliance with said standard RFID data communication protocol.

30. An RFID reader according to claim 27, wherein said modulator modulates said RFID reader identifier into a preamble section of said interrogation sequence.

31. An RFID reader according to claim 27, wherein said modulator modulates said RFID reader identifier into a tag energizing section of said interrogation sequence.

32. An RFID reader according to claim 27, wherein said modulator performs modulation that does not impact an energizing function of said interrogation sequence.

33. A diagnostic probe for an RFID system, said diagnostic probe comprising:
a receiver configured to receive an ID-modulated interrogation sequence having an RFID reader identifier modulated into at least a portion thereof;
a demodulator in communication with said receiver, said demodulator being configured to demodulate said ID-modulated interrogation sequence to obtain an extracted RFID reader identifier; and
processing logic in communication with said demodulator, said processing logic being configured to determine, in response to said extracted RFID reader identifier, the source of said ID-modulated interrogation sequence.

34. A diagnostic probe according to claim 33, wherein said receiver is configured to receive said ID-modulated interrogation sequence in compliance with a standard RFID data communication protocol.

35. A diagnostic probe according to claim 33, wherein:
said ID-modulated interrogation sequence comprises said RFID reader identifier modulated into a preamble section of said interrogation sequence; and
said demodulator is configured to demodulate said preamble section.

36. A diagnostic probe according to claim 33, wherein:
said ID-modulated interrogation sequence comprises said RFID reader identifier modulated into a tag energizing section of said interrogation sequence; and
said demodulator is configured to demodulate said energizing section.
